(19) United States
(12) Patent Application Publication
(10) Pub. No.: US 2008/0052921 A1
(43) Pub. Date: Mar. 6, 2008

(54) Base Plate for Power Scroll Saw

(76) Inventors: Stefano Delfini, Bettlach (CH); Daniel Saegesser, Langenthal (CH); Thomas Ruoff, Kaempfelbach-Bilfingen (DE)

Correspondence Address: Striker Striker Stenby, 103 East Neck Road, Huntington, NY, 11743, US

(21) Appl. No.: 10/564,246

(22) PCT Filed: Jul. 11, 2005
(86) PCT No.: PCT/EP05/53297

§ 371 Date: Jan. 11, 2006

(30) Foreign Application Priority Data
Sep. 21, 2004 (DE) 102004045539.2

(51) Int. Cl. B23D 51/02

(52) U.S. Cl. 30/375; 30/374

(57) ABSTRACT

A base plate (20) for a power scroll saw is disclosed, which has a through opening (15) for a saw blade (13) that is drivable in a reciprocating motion by the power scroll saw. To prevent defective straight cuts and laterally obliquely extending cuts, especially in thick material to be cut, from lateral deflection of the tip of the saw blade in sawing, a guide device (21) with guide elements (22, 23) protruding into the through opening (15) is integrated with the base plate (20). With power scroll saws that have no guide device for laterally guiding the saw blade (13), an improved outcome of sawing can be attained by simply replacing its base plate for the novel base plate (20) disclosed here (FIG. 2).

### PRIOR ART

The invention is based on a base plate for a power scroll saw as generically defined by the preamble to claim 1.

A known power scroll saw (German Patent Disclosure DE 101 19 561 A1), called a hand-guided saber saw, has a pendulum device, with a U-shaped holder secured to the housing of the saber saw and with a support roller located between the legs of the holder, which braces the saw blade on its spine. The support roller is provided with a V-shaped groove, in which the spine of the saw blade is received. In order to suppress a lateral deflection of the pendulum device transversely to the sawing direction during sawing, a guide means is provided, which is secured to the housing of the saber saw or to a base plate, serving as a support for the saber saw on the workpiece to be sawn. The guide means is embodied in forked fashion and on the ends of the fork has guide cheeks, facing toward one another, which engage the holder of the pendulum device, specifically in the region of the holder in which the support roller is located.

A known hand-guided saber saw (International Patent Disclosure WO 02/22297 A1) has a support device with a support roller; this device braces the saw blade on its spine in the sawing direction and is capable as needed of driving it to swing like a pendulum in the sawing direction. In order to prevent lateral deflection of the saw blade transversely to the sawing direction during sawing, the saber saw has a guide device for guidance and lateral bracing of the saw blade, which has two guide elements, contacting the sides of the saw blade facing away from one another, and a control motor, embodied as a spring drive, with which the spacing between the guide elements can be adjusted to the saw blade thickness. The guide device is integrated into the power saw housing and protrudes, in the form of pivot lever tongs, from the housing in the sawing direction in front of the saw blade. The guide elements located on the end of the tongs engage the saw blade above the base plate with its through opening for the saw blade. The guide elements are embodied as roller bodies or ceramic parts. The guide device is coupled with a chucking device, which holds the saw blade, such that the guide elements lift from the saw blade when the chucking device is opened and are placed against the sides of the saw blade when the chucking device is closed. The pivot lever tongs are connected via a joint, and with guide bolts that protrude from their lever arms facing away from the guide elements, they engage grooves in a bearing component that are embodied as extending slightly obliquely away from one another, at an angle of less than 6θ, in the longitudinal direction of the saw blade. Upon displacement of the bearing component, the pivot lever tongs are pivoted along the groove flanks and the guide bolts. Two compression springs engage the bearing component and urge it in the longitudinal direction of the saw blade and seek to adjust the pivot lever tongs via the grooves and guide bolts such that the guide elements on the pivot lever tongs press with spring prestressing against the sides of the saw blade.

### ADVANTAGES OF THE INVENTION

The base plate of the invention for a power scroll saw, as defined by the characteristics of claim 1, has the advantage that because the guide device for the saw blade is integrated with the base plate of the power scroll saw, not only is a space-saving accommodation of the guide device possible, but there is also a retrofitting option for older power scroll saws that are not yet equipped with a guide device. All that has to be done is to replace the base plates, and the power scroll saw provided with the new base plate produces just as good cutting results as new power scroll saws that are available on the market.

By the provisions recited in the further claims, advantageous refinements of and improvements to the base plate defined by claim 1 are possible.

In one advantageous embodiment of the invention, the base plate has a bottom plate with a surrounding frame and a work plate, resting and secured in the bottom plate, and the guide device is located between the bottom plate and the work plate. As a result of this structural provision, on the one hand the base plate has a flat support face, formed by the work plate, for placement on a workpiece when sawing is done, by the power scroll saw connected to the base plate, and on the other, a protected installation space is created for accommodating the guide device.

In an advantageous embodiment of the invention, the guide device has a pusher mechanism, and the guide elements are embodied as flat disk segments, whose spacing from one another, viewed transversely to the longitudinal axis of the bottom plate, is adjustable by means of the pusher mechanism. Because of this structural provision, the guide device is very low in height, and the height of the base plate can be kept low. Because of the adjustable spacing of the disk segments from one another, all saw blades, regardless of their blade thickness, can be guided without wear and with little friction between the disk segments.

In an advantageous embodiment of the invention, the disk segments, on diametrically opposed sides of the through opening, are supported in the bottom plate and/or work plate pivotably about pivot axes oriented perpendicular to the base plate and to the faces of the disk segments. Each disk segment is engaged, spaced apart from the bearing point, by a slide rod, which is pivotably connected to a flat pusher that is displaceable in the sawing direction. The guide device has a manually detachable locking unit for locking the pusher in whatever displacement position it is in at the time.

### DRAWING

The invention is described in further detail below in terms of an exemplary embodiment shown in the drawing. Shown are:

FIG. 1, a schematic perspective elevation view of a power scroll saw with a base plate for placing the saw on a workpiece to be sawn;

FIG. 2, a perspective top view on a base plate with a guide device for the saw blade, as a replacement for the base plate of the power scroll saw in FIG. 1;

FIG. 3, a perspective elevation view of a pusher mechanism of the guide device of FIG. 2;

FIG. 4, an exploded view of the pusher mechanism of FIG. 3.

### DESCRIPTION OF THE EXEMPLARY EMBODIMENT

The power scroll saw 10, shown in perspective and schematically in FIG. 1, has a saw housing 11, in which an electric motor with a gear is located, for driving a lifting rod 12 in an upward- and downward-oriented reciprocating motion. A saw blade 13, which has a sawtoothed strip 131 and a saw blade spine 132 facing away from the strip, is releasably fastened with its fastening shaft to the lifting rod 12. A base plate 14 is secured to the housing 11 and has a through opening 15 for the saw blade 13. The base plate 14 serves to place the power scroll saw 10 on a workpiece and to guide the power scroll saw 10 during the sawing operation. With the spine 132 of the saw blade, the saw blade 13 is braced on a support roller 16, which can additionally impart a pendulum motion, which can be imposed as needed, to the saw blade 13. The support roller 16 is received in a support holder 17, which is fixed in the housing 11. For switching the electric motor on and off, a pushbutton 18 is provided, which is located on the underside of a handle 19 shaped out of the housing 11. Since the saw blade tip is loose, in the sawing operation the tip is typically deflected, resulting in a defective straight cut or a laterally obliquely extending cut in the workpiece. This effect is especially pronounced when thick material is to be cut and often requires a postmachining operation.

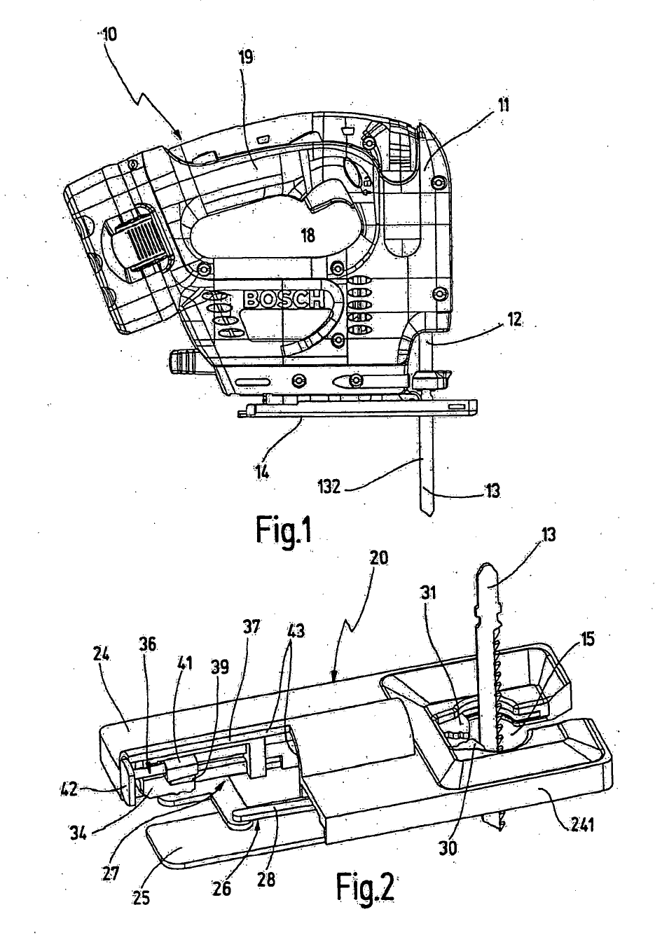

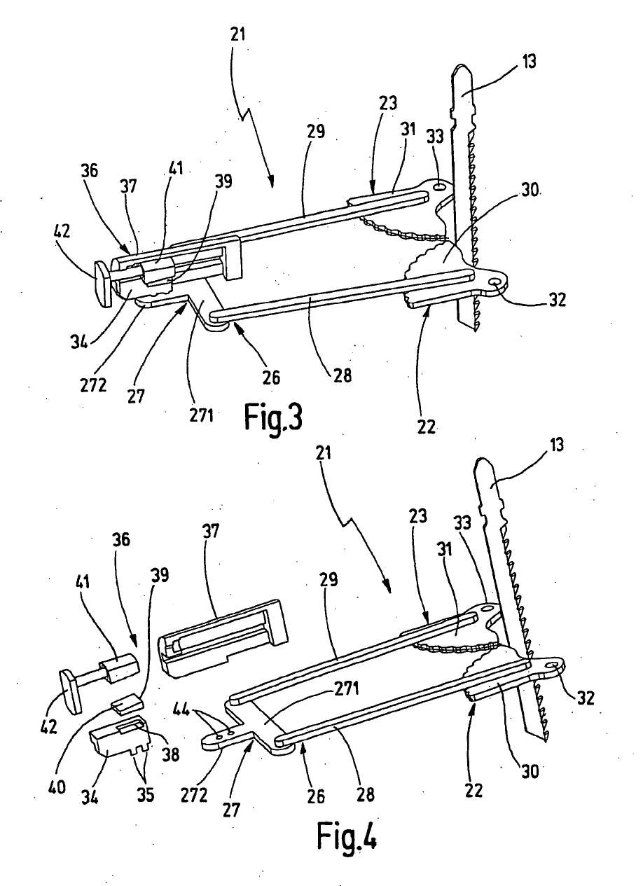

To overcome this disadvantage, the base plate 14 in FIG. 1 is replaced by a base plate 20, shown in perspective from the top in FIG. 2, which can be accomplished by simply replacing the base plate 14 in the housing 11. The base plate 20 shown in FIG. 2 has an integrated guide device 21, with two guide elements 22, 23, which protrude into the through opening 15 of the guide device for the saw blade 13 and which guide and brace the saw blade 13 virtually without play on sides, facing away from one another, of the saw blade 13 and thus prevent a lateral deflection of the saw blade 13. For accommodating the guide device 21, the base plate 20 is composed of a bottom plate 24, with a surrounding frame 241, and a flat work plate 25. The guide device 21 is located between the bottom plate 24 and the work plate 25, and the work plate 25 is inserted into the frame of the bottom plate 24 and secured therein. The guide device 21 has a pusher mechanism 26, which comprises a T-shaped pusher 27, with a crossbar 271 and a middle bar 272 and two slide rods 28, 29, pivotably connected, spaced apart from one another, to the crossbar 271 of the pusher 27. The guide elements 22, 23 are embodied as flat disk segments 30, 31, which are pivotably supported on the bottom plate 24 or the work plate 25 at the through opening 15 on diametrically opposite sides of the base plate 20, each about a pivot axis oriented perpendicular to the base plate 20. The bearing points of the disk segments 30, 31 are marked 32 and 33 in FIGS. 3 and 4. The slide rod 28 is pivotably connected at a spacing from the bearing point 32 of the disk segment 30, and the slide rod 29 is pivotably connected at a spacing from the bearing point 33 of the disk segment 29. A retaining block 34 is rigidly connected to the middle bar 272 of the T-shaped pusher 27. For that purpose, the retaining block 34 has two pegs 35, for instance, which in form-locking fashion engage two holes 44 in the middle bar 272. The retaining block 34 is displaceably guided in a switch housing 37 in the direction of the longitudinal axis of the base plate 20 and is part of a locking unit 36, with which the pusher 27 can be locked in its displacement position at the time. The retaining block 34 has a recess 38, in which a clamping piece 39 is inserted in form-locking fashion in such a way that its wedge face points away from the retaining block 34 and forms a runup ramp 40 for a clamping wedge 41, likewise guided longitudinally displaceably in the switch housing 37. The clamping wedge 41 is connected to an adjusting button 42 and is capable of being braced between the runup ramp 40 on the retaining block 34 and a housing wall of the switch housing 37.

Between the clamping wedge 41 and the switch housing 37, there is a compression spring, not shown here, which is tensed when the adjusting button 42 is pulled out, to the left in terms of FIGS. 2 and 3, and generates a restoring force for the clamping wedge 41. As a result, after the adjusting button 42 is released, the clamping wedge 41 is pushed onto the runup ramp 40 in every position of the retaining block 34 and becomes clamped between the switch housing 37 and the clamping piece 39, so that the retaining block 34 and thus the pusher 27 are fixed nondisplaceably on the switch housing 37. The switch housing 37, like the pusher mechanism 26, is retained between the bottom plate 24 and the work plate 25.

For inserting a saw blade 13, the spring-supported adjusting button 42, which is accessible on the base plate 20, must first be pulled out of the bottom plate 24. As a result, the contact forces between the clamping wedge 41 and the retaining block 34 are overcome. The retaining block 34 can now be grasped; for this purpose, the bottom plate 24 has a recess 43 (FIG. 2) in the region of the switch housing 37. If the retaining block 34 is displaced to the left in FIGS. 2 and 3, then because of the attendant displacement of the pusher 27 via the slide rods 28, 29, the two disk segments 30 are pivoted out of the through opening 15, as can be seen in FIGS. 2 and 3. If the adjusting button 42 is now released again, then the retaining block 34 is locked in that position. The through opening 15 in the base plate 20 is uncovered, and a saw blade 13 can be introduced through the through opening 15 into the lifting rod 12 and clamped.

Once the saw blade 13 has been clamped, the adjusting button 42 is pulled out of the bottom plate 24 again, so that the retaining block 34 is again released. Now via the retaining block 34, the pusher 27 is displaced to the right in FIGS. 2 and 3 so far that the disk segments 30, 31, pivoting outward again as a result of the slide rods 28 and 29, have pressed themselves more or less without play against the sides, facing away from one another, of the saw blade 13. In this position of the retaining block 34, the adjusting button 42 is released, and because of the restoring spring, the clamping wedge 41 becomes wedged on the runup ramp 40 of the retaining block 34 and locks the retaining block in that position. Thus the disk segments 30, 31 are also fixed for laterally guiding the saw blade 13.

1. A base plate for a power scroll saw (10), having a through opening (15) for a saw blade (13) that is drivable to a reciprocating motion by the power scroll saw (10), characterized by an integrated guide device (21), with guide elements (22, 23) protruding into the through opening (15) for guiding and bracing the saw blade (13) transversely to its sawing direction.

2. The base plate in accordance with claim 1, characterized in that a work plate (25) is placed in a bottom plate (24) with a surrounding frame (241), embodied for fastening to the power scroll saw (10), and is secured in it; and that the guide device (21) is located between the bottom plate (24) and the work plate (25).

3. The base plate in accordance with claim 1, characterized in that the guide device (21) has a pusher mechanism (26); and that the guide elements (22, 23) are embodied as pivotable disk segments (30, 31), whose spacing, viewed transversely to the sawing direction, from one another is adjustable by means of the pusher mechanism (26).

4. The base plate in accordance with claim 3, characterized in that the disk segments (30, 31) are supported pivotably, in regions of the bottom plate (24) and/or work plate (25) diametrically opposite one another at the through opening (15), about pivot axes oriented perpendicular to the bottom plate and work plate (24, 25); that each disk segment (30, 31) is engaged, at the spacing from the bearing point (32, 33), by a slide rod (28, 29); and that the slide rods (28, 29) are pivotably connected with transverse spacing from one another to a pusher (27) that is displaceable in the sawing direction.

5. The base plate in accordance with claim 4, characterized in that the guide device (21) has a manually releasable locking unit (36) for locking the pusher (27) in its displacement position at the time.

6. The base plate in accordance with claim 5, characterized in that the locking unit (36) has an adjusting button (42), with a clamping wedge (41) secured to it, that is displaceable on a [noun missing] in the displacement direction of the pusher (27) counter to the force of a restoring spring and a retaining block (34), secured to the pusher (27), with a runup ramp (40), extending in the displacement direction of the pusher (27), for the clamping wedge (41), which cooperates with the wedge face of the clamping wedge (41) for locking the retaining block (34).

7. The base plate in accordance with claim 6, characterized in that the runup ramp (40) is embodied on a clamping piece (39), which rests in form-locking fashion in a recess (38) in the retaining block (34).

8. The base plate in accordance with claim 6, characterized in that the clamping wedge (41) and the retaining block (34) are guided axially displaceably in a switch housing (37) that is retained between the bottom plate (24) and the work plate (25).

9. The base plate in accordance with claim 6, characterized in that the restoring spring is braced on the switch housing (37) and on the clamping wedge (41).

10. The base plate in accordance with claim 8, characterized in that the bottom plate (24), in the region of the switch housing (37), has a recess (43), in which the retaining block (34) can be engaged for displacement in the switch housing (37).

11. A power scroll saw having a housing (11) and a saw blade (13), drivable by a motor to a reciprocating motion, characterized by a base plate (20) in accordance with claim 1.
